(19) United States
(12) Patent Application Publication
(10) Pub. No.: US 2023/0050401 A1
(43) Pub. Date: Feb. 16, 2023

(54) CATHODE STRUCTURE FOR A BATTERY AND METHOD OF FABRICATING THE SAME

(71) Applicant: GM GLOBAL TECHNOLOGY OPERATIONS LLC, Detroit, MI (US)

(72) Inventors: Nicole Ellison, Madison Heights, MI (US); Xiaosong Huang, Novi, MI (US)

(73) Assignee: GM GLOBAL TECHNOLOGY OPERATIONS LLC, Detroit, MI (US)

(21) Appl. No.: 17/401,612

(22) Filed: Aug. 13, 2021

(51) Int. Cl. H01M 4/583; H01M 4/505; H01M 4/525; H01M 4/62; H01M 4/04; H01M 4/36

(52) U.S. Cl. CPC H01M 4/583; H01M 4/505; H01M 4/525; H01M 4/622; H01M 4/0452; H01M 4/364

(57) ABSTRACT

A cathode structure for a battery includes a substrate having an electrically conductive surface and an electrode deposited onto the electrically conductive surface. The electrode is made of two or more electrode materials, including (i) one or more active materials, and (ii) specified weight percentage ranges of multi-walled carbon nanotubes (“MWCNTs”), or milled carbon fibers (“MCFs”), or a mixture of MWCNTs and MCFs. Using the specified weight percentage ranges, the electrode may be produced with a thickness of greater than 120 μm. Also disclosed are a slurry formulation for producing thick electrodes for a battery, and a method of fabricating a cathode structure for a battery.

### INTRODUCTION

This disclosure relates to cathode structures for electric batteries, and to methods of fabricating such cathode structures.

Electric batteries, such as lithium-ion batteries, utilize opposed electrodes—i.e., anodes and cathodes—that are separated from each other spatially but connected to each other electrochemically via a chemical electrolyte. Each electrode may be produced in a variety of ways. For example, fabrication of a cathode may include depositing a slurry of ingredients onto an electrically conductive surface of a substrate, and then curing the slurry by heating it to evaporate away volatile ingredients and to cure or set the remaining ingredients. The volatile ingredients may include a solvent, and the remaining ingredients may include active materials (such as lithium oxide), conductive fillers and polymeric binders.

When utilizing the aforementioned approach of depositing a slurry and then heating it to form an electrode, there is a limit to how thick and/or tall the resulting electrode may be made, due to the rheological properties of the slurry and other factors.

### SUMMARY

According to one embodiment, a cathode structure for a battery includes a substrate having an electrically conductive surface, and an electrode deposited onto the electrically conductive surface. The electrode is made of two or more electrode materials, including (i) one or more active materials, and (ii) 0.05-10.0 weight % of multi-walled carbon nanotubes (“MWCNTs”), or 0.1-20.0 weight % of milled carbon fibers (“MCFs”), or 0.3-20.0 weight % of a mixture of MWCNTs and MCFs, wherein the electrode has a thickness of greater than 120 μm.

In this embodiment, the two or more electrode materials may be homogenously mixed with each other, and the one or more active materials may be at least one of lithium manganese oxide, lithium manganese iron phosphate, nickel cobalt manganese aluminum oxide, nickel cobalt aluminum oxide and lithium nickel cobalt manganese oxide. The two or more electrode materials may further include carbon particles and/or single-walled carbon nanotubes, and the two or more electrode materials may further include a polymeric binder.

The MWCNTs and/or the MCFs may be randomly dispersed throughout the electrode so as to provide additional electrical conductivity between adjacent particles of the active material. Further, each of the MWCNTs may be bonded with a carboxylic acid functional group, a hydroxyl functional group, an amine functional group, an epoxide functional group or an ester functional group. An electrode loading provided by the electrode may be at least 5.0 mAh/cm²; more specifically, the electrode loading provided by the electrode may be at least 5.0 mAh/cm² and less than or equal to 6.0 mAh/cm². Each of the MWCNTs may have a first diameter of greater than or equal to 5 nm and less than or equal to 100 nm, and each of the MCFs may have a second diameter of greater than or equal to 2 μm and less than or equal to 20 μm and a length of at least 10 μm.

According to another embodiment, a slurry formulation for producing thick electrodes for a battery includes: 40-85 weight % of active material; and 0.02-8.0 weight % of multi-walled carbon nanotubes, or 0.05-16.0 weight % of milled carbon fibers, or 0.1-16.0 weight % of a mixture of multi-walled carbon nanotubes and milled carbon fibers. This slurry formulation has a solids content of greater than 66 weight %. The slurry formulation may further include one or more of (i) 0.5-8.0 weight % of carbon particles and/or single-walled carbon nanotubes, (ii) 0.5-15 weight % of polymeric binder, and (iii) 20-50 weight % of a solvent.

According to yet another embodiment, a method of fabricating a cathode structure for a battery includes: (i) mixing multi-walled carbon nanotubes and/or milled carbon fibers with carbon black and a solvent to produce a first mixture; (ii) mixing a polymeric binder with the first mixture to produce a second mixture; (iii) mixing active material with the second mixture to produce a third mixture; (iv) coating an electrically conductive surface of a substrate with the third mixture to produce a coated substrate; and (v) heating the coated substrate to a temperature of at least 50° C. so as to substantially remove the solvent. The method may further include mixing additional solvent with the third mixture.

The active material may be at least one of lithium manganese oxide, lithium manganese iron phosphate, nickel cobalt manganese aluminum oxide, nickel cobalt aluminum oxide and lithium nickel cobalt manganese oxide. The third mixture may have a solids content of greater than 66 weight %. The step of heating the coated substrate may produce an electrode having a thickness of greater than 120 μm. Further, each of the multi-walled carbon nanotubes may be bonded with a carboxylic acid functional group, a hydroxyl functional group, an amine functional group, and epoxide functional group or an ester functional group.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic cross-sectional side view of a battery.

FIG. 2 is a schematic side view of a cathode structure for a battery.

FIG. 3 is a magnified schematic perspective view of an end portion of a multi-walled carbon nanotube.

FIG. 4 is a magnified scanning electron microscopy view of milled carbon fibers.

FIG. 5 is a schematic cross-sectional side view of an embodiment of a cathode structure, containing multi-walled carbon nanotubes.

FIG. 6 is a schematic cross-sectional side view of another embodiment of a cathode structure, containing milled carbon fibers.

FIG. 7 is a schematic cross-sectional side view of yet another embodiment of a cathode structure, containing a mixture of multi-walled carbon nanotubes and milled carbon fibers.

FIG. 8 is a block diagram showing various materials used to make an electrode.

FIG. 9 is a block diagram showing various ingredients used to make a slurry formulation.

FIG. 10 is a flowchart for a method of fabricating a cathode structure for a battery.

FIG. 11 is a schematic cross-sectional side view of a baseline cathode structure, containing no multi-walled carbon nanotubes or milled carbon fibers.

FIG. 12 is a chart comparing discharge capacity and retention for a cathode structure containing multi-walled carbon nanotubes versus a baseline cathode structure without multi-walled carbon nanotubes.

FIG. 13 is a chart comparing discharge capacity and retention for a cathode structure containing milled carbon fibers versus a baseline cathode structure without milled carbon fibers.

FIG. 14 is a chart comparing charge capacity and retention for several charge rates for a cathode structure containing multi-walled carbon nanotubes versus a baseline cathode structure without multi-walled carbon nanotubes.

FIG. 15 is a chart comparing charge capacity and retention for several charge rates for a cathode structure containing a combination of multi-walled and single-walled carbon nanotubes versus a cathode structure containing multi-walled carbon nanotubes without any single-walled carbon nanotubes.

### DETAILED DESCRIPTION

Referring now to the drawings, wherein like numerals indicate like parts in the several views, a cathode structure 20 for a battery 10, a slurry formulation 70 for producing thick electrodes 26 for a battery 10, and a method 100 of fabricating a cathode structure 20 for a battery 10 are shown and described herein. The cathode structure 20, slurry formulation 70 and method 100 of the present disclosure utilize multi-walled carbon nanotubes (“MWCNTs”) 32 and/or milled carbon fibers (“MCFs”) 34 in unique ways to produce electrodes 26 which are much thicker than may be done using previously known approaches. For example, the electrodes 26 and cathode structures 20 produced using the slurry formulation 70 and method 100 described herein may produce thick electrodes 26 which may be over 120 μm high.

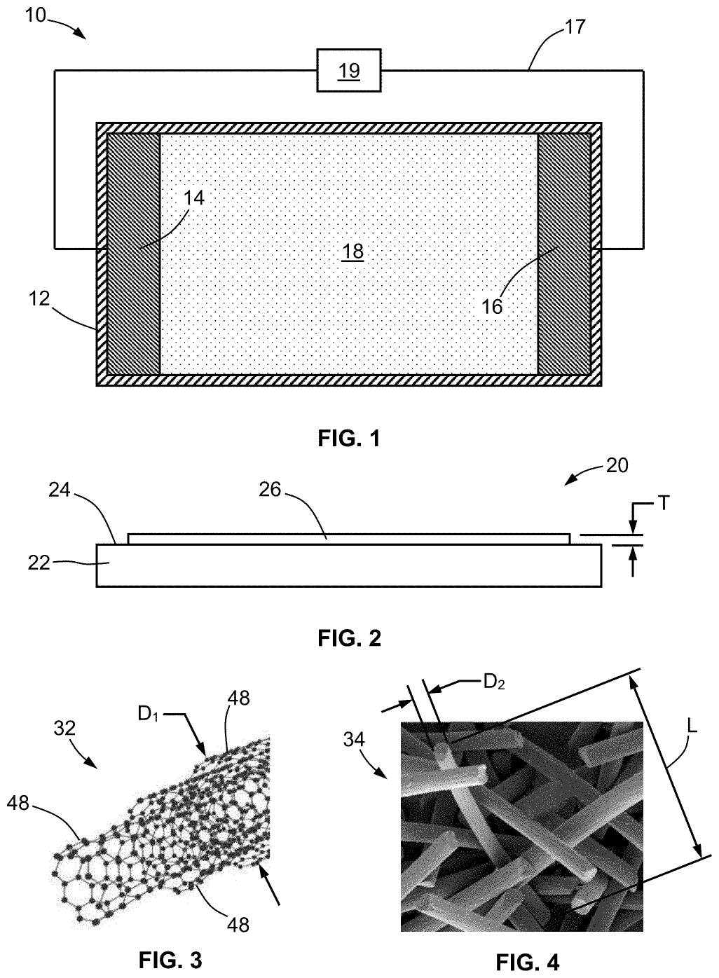

FIG. 1 shows a schematic side view of a battery 10 having an outer housing 12, an anode 14 and a cathode 16 disposed within the housing 12 and situated at opposite ends of the housing 12, and an electrolyte 18 disposed between and electrically connecting the anode 14 and cathode 16. An external electrical path 17 connects the anode 14 and the cathode 16 to each other, with the electrical path 17 passing through a load 19 (e.g., one or more motors, electrical/electronic components, resistive elements, etc.). Turning now to the cathode 16, FIG. 11 shows a schematic cross-sectional side view of a baseline cathode structure 90 (i.e., an ordinary cathode construction), which contains no MWCNTs 32 or MCFs 34. The baseline cathode structure 90 contains a mixture of two or more electrode materials 28, such as active material 30 and carbon particles 46 suffused within a polymeric binder 50, formed on an electrically conductive surface 24 of a substrate 22 so as to form an electrode 26.

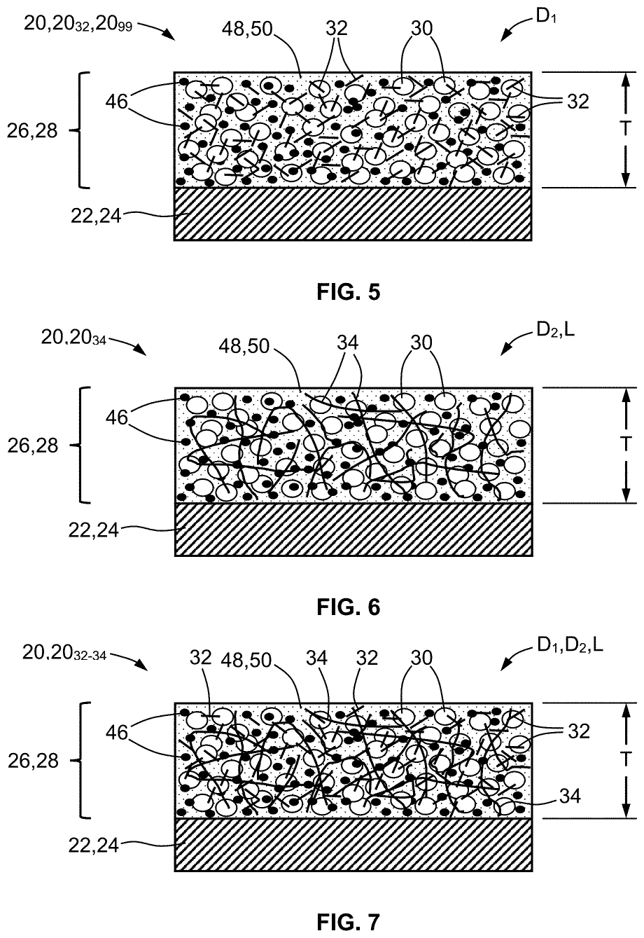

FIG. 2 shows one embodiment of a cathode structure 20 for a battery 10 according to the present disclosure, and FIGS. 5-7 show three different configurations of this embodiment. The cathode structure 20 includes a substrate 22 having an electrically conductive surface 24, and an electrode 26 deposited or coated onto the electrically conductive surface 22. The substrate 22 itself may be made of an electrically conductive material, in which case one or more (and perhaps all) of its surfaces may be electrically conductive, such as if the substrate 22 were a plate of uncoated or uninsulated copper, aluminum or the like. Or, the substrate 22 may be made of a material that is partially or fully non-conductive, in which case a conductive layer of material may be plated or otherwise disposed thereon to provide the electrically conductive surface 24. The electrode 26, which is deposited or otherwise disposed on the substrate 22, is made of two or more electrode materials 28. These electrode materials 28 include a combination of (i) one or more active materials 30, and (ii) either MWCNTs 32, or MCFs 34, or a mixture of MWCNTs 32 and MCFs 34. That is, the electrode 26 may be made of (a) one or more active materials 30 and MWCNTs 32 (FIG. 5), or (b) one or more active materials 30 and MCFs 34 (FIG. 6), or (c) one or more active materials 30 and a mixture of MWCNTs 32 and MCFs 34 (FIG. 7).

Note that FIGS. 1-2, 5-7 and 11 are simplified schematic drawings whose respective elements are not necessarily drawn to scale with respect to each other. For example, in some embodiments of FIG. 1, there may be more than one anode 14, one cathode 16 and one electrolyte region 18, and the thickness of each electrolyte region 18 may be much thinner than its neighboring anode 14 and cathode 16. For instance, each electrolyte region 18 may be about 20 microns thick, and each of the anodes 14 and cathodes 16 may be about 20 to 150 microns thick. And while FIG. 2 shows the substrate 22 being much thicker than the electrode 26, in some embodiments the substrate 22 may be the same thickness as or much thinner than the electrode 26. For instance, the substrate 22 may be 10 to 20 microns thick, and the electrode 26 may be over 120 microns thick. (For the avoidance of doubt, it may be noted that 1 micron is equivalent to 1 μm, 1 micrometer, and 1×10⁻⁶ meter.)

FIG. 3 shows a magnified schematic perspective view of an end portion of a MWCNT 32, and FIG. 4 shows a magnified scanning electron microscopy view of a collection of MCFs 34. Note that the MWCNT 32 of FIG. 3 exhibits an overall shape that is somewhat tubular or cylindrical, being made of three (as shown here) or more concentric single-walled carbon nanotubes (“SWCNTs”) 48. Here, each of the three (or more) SWCNTs 48 is made of a respective layer of graphene (composed of a series of interconnected carbon atoms), with the overall MWCNT 32 having a first diameter Di which is the outer diameter of the outermost of the concentric SWCNTs 48. This first diameter D₁ may be greater than or equal to 5 nm, and less than or equal to 100 nm. In FIG. 4, each of the MCFs 34 may have a second diameter D₂ of greater than or equal to 2 μm and less than or equal to 20 μm, and a length L of at least 10 μm. (It should be noted that while SWCNTs 48, MWCNTs 32 and MCFs 34 share some similar properties with each other, they also have some very different properties from each other as well, such that they are not universally interchangeable with each other.)

Returning to FIGS. 5-7, the MWCNTs 32 (FIG. 5), the MCFs 34 (FIG. 6), or the mixture of MWCNTs 32 and MCFs 34 (FIG. 7) may each be provided within a respective weight percentage range of the overall weight of the electrode materials 28. Specifically, the MWCNTs 32 may represent 0.05-10.0 weight % of the total weight of electrode materials 28; the MCFs 34 may represent 0.1-20.0 weight % of the total weight of electrode materials 28; and a mixture of MWCNTs 32 and MCFs 34 may represent 0.3-20.0 weight % of the total weight of electrode materials 28. (Note that as used herein, “weight %” means “percent by weight”.) In each of these cases, the electrode 26 may have a thickness T (i.e., a height above the conductive surface 24) of greater than 120 μm. As illustrated in FIGS. 5-7, the MWCNTs 32 and/or the MCFs 34 may be randomly and/or homogeneously dispersed throughout the electrode 26 so as to provide additional or enhanced electrical conductivity between adjacent particles of the active material 30, thus improving the overall electrical conductivity of the thick electrode 26.

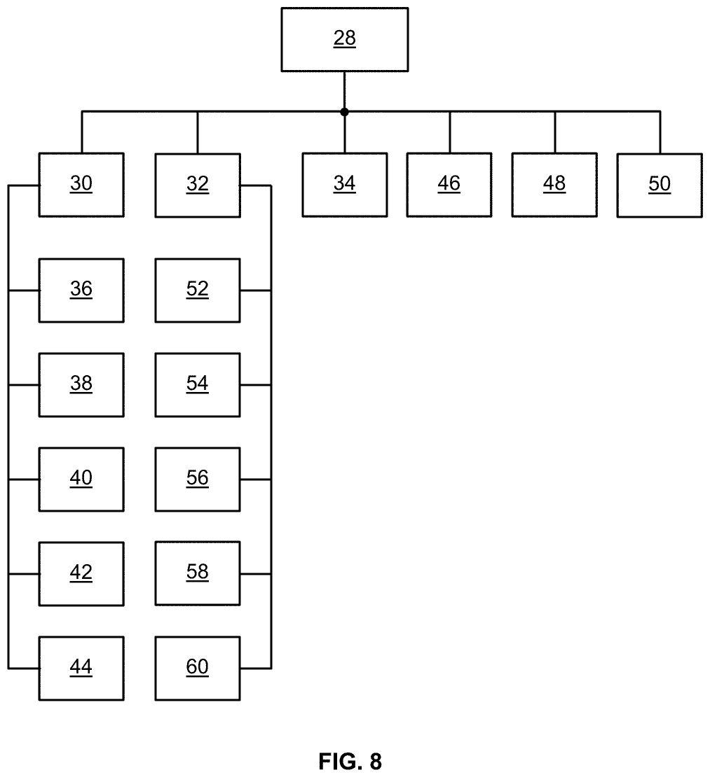

FIG. 8 shows a block diagram of various electrode materials 28 which may be used to make an electrode 26. In this embodiment, the two or more electrode materials 28 may be homogenously mixed with each other. The one or more active materials 30 may include lithium manganese oxide (“LMO”) 36, lithium manganese iron phosphate (“LMFP” or “LFP”, sometimes also called lithium manganese ferro phosphate) 38, nickel cobalt manganese aluminum oxide (“NCMA”) 40, nickel cobalt aluminum oxide (“NCA”) 42, lithium nickel cobalt manganese oxide (“NMC”) 44, or a mixture of two or more of the foregoing. The two or more electrode materials 28 may further include carbon particles 46 and/or SWCNTs 48, and the two or more electrode materials 28 may further include a polymeric binder 50, such as polyvinylidene fluoride (“PVDF”).

As also shown in FIG. 8, each of the MWCNTs 32 may be bonded with a carboxylic acid functional group 52 (e.g., RCOOH), a hydroxyl functional group 54 (e.g., ROH), an amine functional group 56 (RNH₂), an epoxide functional group 58 (e.g., a cyclic ether with a three-atom ring), or an ester functional group 60 (e.g., RCOOR′). Each of these functional groups may add chemical, rheological, mechanical and/or other properties to the electrode 26, the cathode structure 20, the slurry formulation 70 and/or the method 100 which would not be available if MWCNTs 32 without such functional groups were used.

In one exemplary formulation, the cathode structure 20 may be 97.0 weight % active material(s) 30, 0.3 weight % MWCNT 32 and/or MCF 34, 1.1 weight % carbon black 46, 0.1 weight % SWCNTs 48, and 1.5 weight % PVDF. In another exemplary formulation, the cathode structure 20 may be 97.0 weight % active material(s) 30, 0.3 weight % MWCNT 32 and/or MCF 34, 1.2 weight % carbon black 46, and 1.5 weight % PVDF.

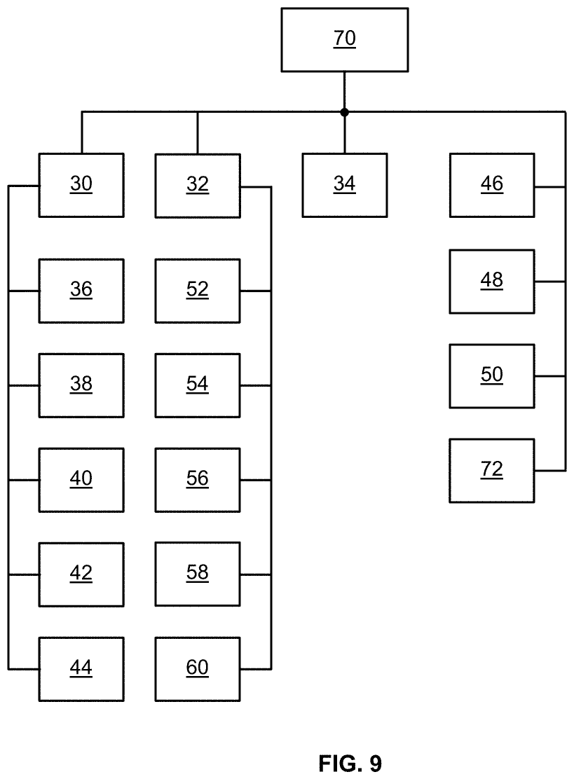

FIG. 9 shows a block diagram illustrating another embodiment, showing various ingredients used to make a slurry formulation 70 for producing thick electrodes 26 for a cathode structure 20 and/or a battery 10. The slurry formulation 70 includes a combination of: (i) one or more active materials 30; and (ii) either MWCNTs 32, or MCFs 34, or a mixture of MWCNTs 32 and MCFs 34. (That is, the slurry formulation 70 may be made of (a) one or more active materials 30 and MWCNTs 32, or (b) one or more active materials 30 and MCFs 34, or (c) one or more active materials 30 and a mixture of MWCNTs 32 and MCFs 34.) Specifically, the slurry formulation 70 may include (i) 40-85 weight % of active material(s) 30; and (ii) 0.02-8.0 weight % of MWCNTs 32, or 0.05-16.0 weight % of MCFs 34, or 0.1-16.0 weight % of a mixture of MWCNTs 32 and MCFs 34.

The slurry formulation 70 may further include one or more of (iii) 0.5-8.0 weight % of carbon particles 46 and/or SWCNTs 48, (iv) 0.5-15 weight % of polymeric binder 50 (such as PVDF), and (v) 20-50 weight % of a solvent 72 (such as n-methyl-2-pyrrolidone, also known as “NMP” or C₅H₉NO). The slurry formulation 70 is configured to have a solids content of greater than 66 weight % in its as-mixed or “wet” form before being heated according to a predetermined temperature-versus-time profile for setting/curing/drying. After exposure to heat according to this profile, the previous “wet” slurry formulation 70 will set or cure into a “dry” form wherein substantially all of the solvent 72 has been evaporated away and the electrode(s) 26 formed may have the “dry” MWCNT and/or MCF weight % ranges specified above for a finished electrode 26—namely, the MWCNTs 32 may represent 0.05-10.0 weight % of the total weight of electrode materials 28; the MCFs 34 may represent 0.1-20.0 weight % of the total weight of electrode materials 28; and a mixture of MWCNTs 32 and MCFs 34 may represent 0.3-20.0 weight % of the total weight of electrode materials 28.

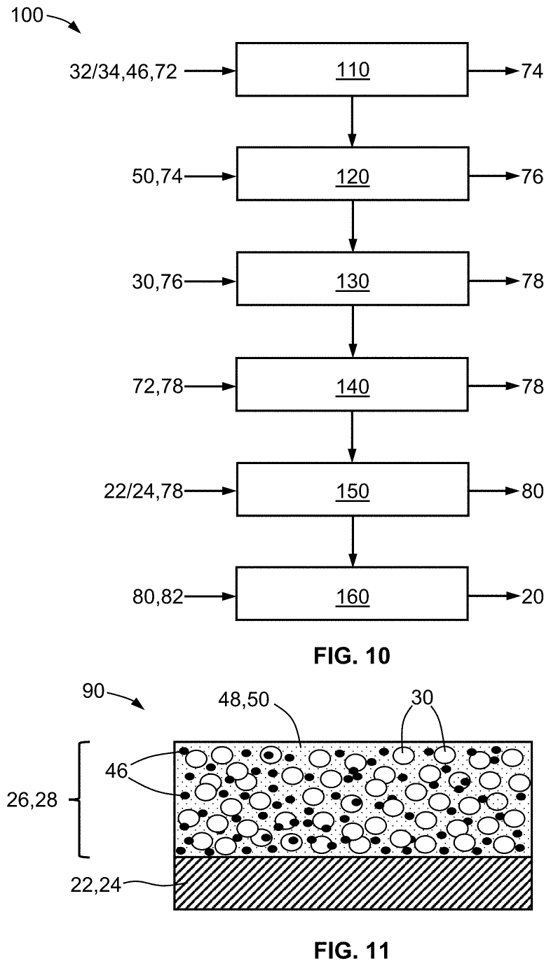

FIG. 10 shows a flowchart for a method 100 of fabricating a cathode structure 20 for a battery 10. Note that the ingredients or “inputs” are shown to the left of each block or step, and the results or “outputs” are shown to the right of each block or step. The method 100 includes, at block 110, the step of mixing MWCNTs 32 and/or MCFs 34 with carbon black/carbon particles 46 (which may include SWCNTs 48) and a solvent 72 to produce a first mixture 74. At block 120, a polymeric binder 50 is mixed with the first mixture 74 to produce a second mixture 76, and at block 130 active material 30 is mixed with the second mixture 76 to produce a third mixture 78. At block 140, an optional step of mixing additional solvent 72 with the third mixture 78 may be performed. At block 150, an electrically conductive surface 24 of a substrate 22 is coated with the third mixture 78 to produce a coated substrate 80. And at block 160, the coated substrate 80 is heated (with heat 82, such as from an oven or other heating source) to a temperature of at least 50° C. so as to substantially remove the solvent 72, and optionally to cure or set the polymeric binder 50, thereby producing the finished cathode structure 20. Note that the slurry formulation 70 (represented by FIG. 9) may be used in the method 100 (represented by FIG. 10) to produce the electrode 26 and/or cathode structure 20 (represented by one or more of FIGS. 2 and 5-7) made of the two or more electrode materials 28 discussed above (represented by FIG. 8), which includes either MWCNTs 32 (FIGS. 3 and 5) or MCFs 34 (FIGS. 4 and 6) or both MWCNTs 32 and MCFs 34 (FIGS. 3, 4 and 7).

In this method 100, the active material 30 may be at least one of lithium manganese oxide 36, lithium manganese iron phosphate 38, nickel cobalt manganese aluminum oxide 40, nickel cobalt aluminum oxide 42 and lithium nickel cobalt manganese oxide 44, and the third mixture 78 may have a solids content of greater than 66 weight %. The step 160 of heating the coated substrate 80 may produce an electrode 26 having a thickness or height T of greater than 120 μm. Further, each of the MWCNTs 32 may be bonded with a carboxylic acid functional group 52, a hydroxyl functional group 54, an amine functional group 56, and epoxide functional group 58 or an ester functional group 60.

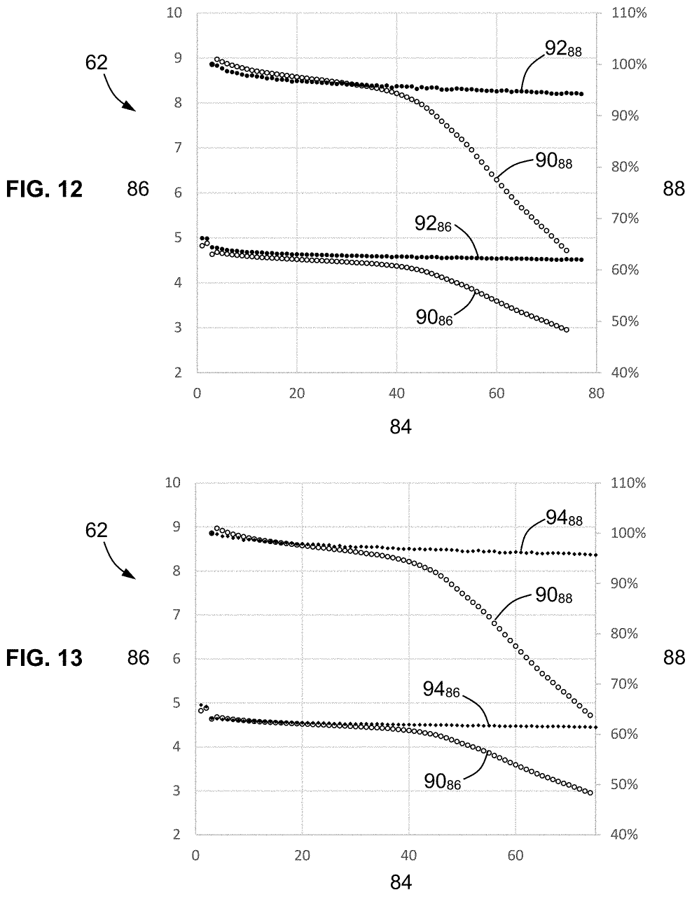

FIGS. 12-15 show various charts comparing charge and discharge capacities (and retention percentages) among (i) cathode structures 20₃₂ containing MWCNTs 32 (and SWCNTs 48), (ii) cathode structures 20₃₄ containing MCFs 34, (iii) cathode structures 20₉₉ containing MWCNTs 32 without any SWCNTs 48, and (iv) a baseline cathode structure 90 containing no MWCNTs 32 or MCFs 34. For the cathode structures 20₃₂ containing MWCNTs 32 (and SWCNTs 48), an exemplary formulation or make-up may include 97 weight % active material(s) 30, 0.3 weight % MWCNTs 32, 0.1 weight % SWNCTs 48, 1.1 weight % carbon particles 46 and 1.5 weight % PVDF binder 50. For the cathode structures 20₃₄ containing MCFs 34, an exemplary formulation or make-up may include 97 weight % active material(s) 30, 0.3 weight % MCFs 34, 0.1 weight % SWNCTs 48, 1.1 weight % carbon particles 46 and 1.5 weight % PVDF binder 50. For the cathode structures 20₉₉ containing MWCNTs 32 but no SWCNTs 48, an exemplary formulation or make-up may include 97 weight % active material(s) 30, 0.3 weight % MWCNTs 32, 1.2 weight % carbon particles 46 and 1.5 weight % PVDF binder 50. And for the baseline cathode structure 90, an exemplary formulation or make-up may include 97 weight % active material(s) 30, 0.1 weight % SWNCTs 48, 1.4 weight % carbon particles 46 and 1.5 weight % PVDF binder 50.

FIG. 12 shows a chart comparing discharge capacity and discharge capacity retention for a cathode structure 20₃₂ containing MWCNTs 32 (FIG. 5), versus a baseline cathode structure 90 which is substantially the same as the MWCNT-containing cathode structure 20₃₂ but which does not contain MWCNTs 32 (FIG. 11). The chart shows discharge capacity (measured in mAh/cm²) on the left vertical axis 86, and discharge capacity retention (measured in %) on the right vertical axis 88, both of which are plotted as a function of the number of cycles run as shown on the bottom horizontal axis 84. For this chart, an electrode loading 62 of about 5.0 mAh/cm² was used. Reference numeral 90 and open circular markers (∘) indicate the plots for the baseline cathode structure 90, while reference numeral 92 and filled circular markers (●) indicate the plots for the cathode structure 20₃₂ which contains MWCNTs 32. Subscripts 86 and 88 indicate which respective vertical axis a given plot is plotted against. For example, 90₈₆ is a plot of the discharge capacity of the baseline structure 90 (against the left vertical axis 86), 90₈₈ is a plot of the discharge capacity retention % of the baseline structure 90 (against the right vertical axis 88), 92₈₆ is a plot of the discharge capacity of the cathode structure 20₃₂ (against the left vertical axis 86), and 92₈₈ is a plot of the discharge capacity retention % of the cathode structure 20₃₂ (against the right vertical axis 88).

In FIG. 12, note that around 40 cycles, the plots of the discharge capacity 90₈₆ and discharge capacity retention 90₈₈ for the baseline structure 90 (without MWCNTs 32) begin to fall off, while the plots of the discharge capacity 92₈₆ and discharge capacity retention 92₈₈ for the cathode structure 20₃₂ (containing MWCNTs 32) remain fairly constant. This shows that the use of MWCNTs 32 in cathode structures 20, 20₃₂ as described herein is much more effective than ordinary cathode constructions 90 for maintaining the discharge capacity and discharge capacity retention for an extended number of cycles.

FIG. 13 shows a chart comparing discharge capacity and discharge capacity retention for a cathode structure 20₃₄ containing MCFs 34 (FIG. 6), versus a baseline cathode structure 90 which is substantially the same as the MCF-containing cathode structure 20₃₄ but which does not contain MCFs 34 (FIG. 11). The chart shows discharge capacity (measured in mAh/cm²) on the left vertical axis 86, and discharge capacity retention (measured in %) on the right vertical axis 88, both of which are plotted as a function of the number of cycles run as shown on the bottom horizontal axis 84. For this chart, an electrode loading 62 of about 5.0 mAh/cm² was used. Reference numeral 90 and open circular markers (∘) indicate the plots for the baseline cathode structure 90, while reference numeral 94 and filled diamond markers (♦) indicate the plots for the cathode structure 20₃₄ which contains MCFs 34. Subscripts 86 and 88 indicate which respective vertical axis a given plot is plotted against. For example, 90₈₆ is a plot of the discharge capacity of the baseline structure 90 (against the left vertical axis 86), 90₈₈ is a plot of the discharge capacity retention % of the baseline structure 90 (against the right vertical axis 88), 94₈₆ is a plot of the discharge capacity of the cathode structure 20₃₄ (against the left vertical axis 86), and 94₈₈ is a plot of the discharge capacity retention % of the cathode structure 20₃₄ (against the right vertical axis 88).

In FIG. 13, note that around 40 cycles, the plots of the discharge capacity 90₈₆ and discharge capacity retention 90₈₈ for the baseline structure 90 (without MCFs 34) begin to fall off, while the plots of the discharge capacity 94₈₆ and discharge capacity retention 94₈₈ for the cathode structure 20₃₄ (containing MCFs 34) remain fairly constant. This shows that the use of MCFs 34 in cathode structures 20, 20₃₄ as described herein is much more effective than ordinary cathode constructions 90 for maintaining the discharge capacity and discharge capacity retention for an extended number of cycles.

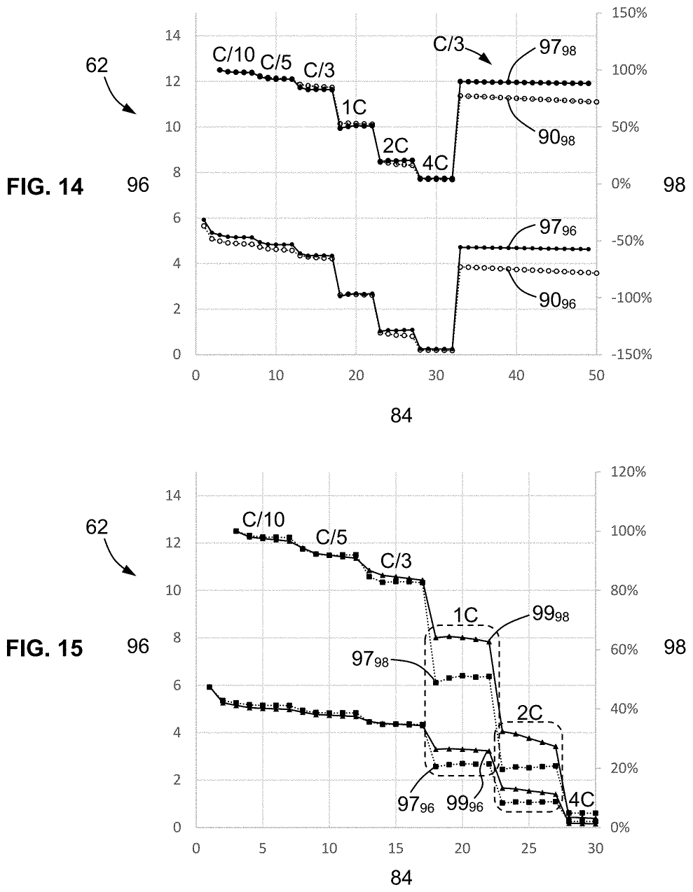

FIG. 14 is a chart comparing charge capacity and charge capacity retention for several charge states for a cathode structure 20₃₂ containing MWCNTs 32 (FIG. 5), versus the baseline cathode structure 90 which does not contain MWCNTs 32 (FIG. 11). The chart shows charge capacity (measured in mAh/cm²) on the left vertical axis 96, and charge capacity retention (measured in %) on the right vertical axis 98, both of which are plotted as a function of the number of cycles run as shown on the bottom horizontal axis 84. For this chart, an electrode loading 62 of about 5.6 to 5.9 mAh/cm² was used. Reference numeral 90 and open square markers (□) indicate the plots for the baseline cathode structure 90, while reference numeral 97 and filled square markers (▪) indicate the plots for the cathode structure 20₃₂ which contains MWCNTs 32. Subscripts 96 and 98 indicate which respective vertical axis a given plot is plotted against. For example, 90₉₆ is a plot of the charge capacity of the baseline structure 90 (against the left vertical axis 96), 90₉₈ is a plot of the charge capacity retention % of the baseline structure 90 (against the right vertical axis 98), 97₉₆ is a plot of the charge capacity of the cathode structure 20₃₂ (against the left vertical axis 96), and 97₉₈ is a plot of the charge capacity retention % of the cathode structure 20₃₂ (against the right vertical axis 98). The chart labels containing the letter “C” indicate various “C rates” or charge rates, with “1C” representing a nominal or normal charge rate, “4C” representing a very fast charge rate, and “C/10” representing a very slow charge rate. Thus, the plots start out at a charge rate of C/10 and steadily increase up to a charge rate of 4C through about the 33^{rd} cycle, at which point the charge rate of C/3 is set for the remaining cycles.

In FIG. 14, note that when the charge rate is changed from 4C to C/3 at about the 33^{rd} cycle, the plots of the charge capacity 97₉₆ and charge capacity retention 97₉₈ for the cathode structure 20₃₂ (containing MWCNTs 32) remain fairly constant and at a relatively higher level, as compared to the plots of the charge capacity 90₉₆ and charge capacity retention 90₉₈ for the baseline structure 90 (without MWCNTs 32) which are relatively lower and begin to slowly decrease as cycling continues. This shows that the use of MWCNTs 32 in cathode structures 20, 20₃₂ as described herein is much more effective than ordinary cathode constructions 90 at recovering back to (and maintaining) previous charge states.

FIG. 15 is a chart comparing charge capacity and charge capacity retention for several charge states for a cathode structure 20₃₂ containing a combination of MWCNTs 32 and SWCNTs 48, versus a cathode structure 20₉₉ containing MWCNTs 32 without any SWCNTs 48. The chart shows charge capacity (measured in mAh/cm²) on the left vertical axis 96, and charge capacity retention (measured in %) on the right vertical axis 98, both of which are plotted as a function of the number of cycles run as shown on the bottom horizontal axis 84. For this chart, an electrode loading 62 of about 5.6 to 5.9 mAh/cm² was used, which was the same as that used in FIG. 14. Also note that the plots of charge capacity 97₉₆ and charge capacity retention 97₉₈ for the cathode structure 20₃₂ (which contains MWCNTs 32 and SWCNTs 48) from the first 30 cycles of FIG. 14 are repeated here in FIG. 15, and are overlaid with the plots of charge capacity 99₉₆ and charge capacity retention 99₉₈ for the cathode structure 20₉₉ (which contains MWCNTs 32 but no SWCNTs 48). Reference numeral 97 and filled square markers (▪) indicate the plots for the cathode structure 20₃₂ which contains MWCNTs 32 and SWCNTs 48, while reference numeral 99 and filled triangular markers (▴) indicate plots for the cathode structure 20₉₉ which contains MWCNTs 32 but no SWCNTs 48. Subscripts 96 and 98 indicate which respective vertical axis a given plot is plotted against. For example, 97₉₆ is a plot of the charge capacity of the cathode structure 20₃₂ (against the left vertical axis 96), 97₉₈ is a plot of the charge capacity retention % of the cathode structure 20₃₂ (against the right vertical axis 98), 99₉₆ is a plot of the charge capacity of the cathode structure 20₉₉ (against the left vertical axis 96), and 99₉₈ is a plot of the charge capacity retention % of the cathode structure 20₉₉ (against the right vertical axis 98).

In FIG. 15, note that the two plots 97₉₆, 99₉₆ for charge capacity are about the same as each other for all charge rates shown, except for the 1C and 2C charge rates; likewise, the two plots 97₉₈, 99₉₈ for charge capacity retention are about the same as each other for all the charge rates shown, except for the 1C and 2C charge rates. Note that a large dashed rounded rectangle has been drawn around the 1C plots, and a smaller dashed rounded rectangle has been drawn around the 2C plots, in order to highlight these two particular charge rates. Within these two charge rates, it appears that the cathode structure 20₉₉ containing MWCNTs 32 but no SWCNTs 48 provides a higher charge capacity and charge capacity retention than does the cathode structure 20₃₂ that contains both MWCNTs 32 and SWCNTs 48. Thus, for one or more charge rates, a cathode structure 20₉₉ containing MWCNTs 32 but no SWCNTs 48 may provide a higher charge capacity and charge capacity retention than a similar cathode structure 20₃₂ containing both MWCNTs 32 and SWCNTs 48.

Utilizing the approaches described above, an electrode loading 62 provided by the electrode 26 (sometimes referred to as electrode loading capacity 62) may be at least 5.0 mAh/cm². More specifically, the electrode loading 62 provided by the electrode 26 may be at least 5.0 mAh/cm² and less than or equal to 6.0 mAh/cm². Since the electrode loading capacity 62 of ordinary deposited electrodes is often in the range of 2 to 3 mAh/cm², and in some cases up to as much as 4 mAh/cm² (e.g., for short spikes or duty cycles), it may be appreciated that the electrode loading capacity 62 provided by the thick electrodes 26 of the present disclosure is an improvement over previous approaches. It should also be noted that while the above cathode structure 20, slurry formulation 70 and method 100 have been described as applying to cathodes 16 and their fabrication, the same structure 20, slurry formulation 70 and method 100 may also apply to anodes 14 and their fabrication as well.

The use of MWCNTs 32 and/or MCFs 34 in the cathode structure 20, slurry formulation 70 and method 100 as described above provides benefits and technical advantages not offered by competing structures, formulations and methods. First, they enable thicker electrodes 26, which may have a height or thickness T of over 120 μm. Second, they facilitate a more uniform electrical conductivity across the electrode 26 in the x-, y- and z-directions during battery cycling to enhance the electrochemical performance of the battery 10. Third, due to the unique morphology and surface chemistry offered by MWCNTs 32 and/or MCFs 34, the rheological properties of the slurry formulation 70 may be improved, allowing for higher solids content which is beneficial during the thick electrode deposition process. Fourth, cycle life performance may be increased. And fifth, electrode loading capacity 62 is improved.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “for the most part”, “to a significant extent” and/or “to a large degree”, and do not necessarily mean “perfectly”, “completely”, “strictly” or “entirely”.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A cathode structure for a battery, comprising:
a substrate having an electrically conductive surface; and
an electrode deposited onto the electrically conductive surface, wherein the electrode is made of two or more electrode materials including:
one or more active materials; and
0.05-10.0 weight % of multi-walled carbon nanotubes (“MWCNTs”), or 0.1-20.0 weight % of milled carbon fibers (“MCFs”), or 0.3-20.0 weight % of a mixture of MWCNTs and MCFs;
wherein the electrode has a thickness of greater than 120 μm.

2. A cathode structure according to claim 1, wherein the two or more electrode materials are homogenously mixed with each other.

3. A cathode structure according to claim 1, wherein the one or more active materials is at least one of lithium manganese oxide, lithium manganese iron phosphate, nickel cobalt manganese aluminum oxide, nickel cobalt aluminum oxide and lithium nickel cobalt manganese oxide.

4. A cathode structure according to claim 1, wherein the two or more electrode materials further includes carbon particles and/or single-walled carbon nanotubes.

5. A cathode structure according to claim 1, wherein the two or more electrode materials further includes a polymeric binder.

6. A cathode structure according to claim 1, wherein the MWCNTs and/or the MCFs are randomly dispersed throughout the electrode so as to provide additional electrical conductivity between adjacent particles of the active material.

7. A cathode structure according to claim 1, wherein each of the MWCNTs is bonded with a carboxylic acid functional group, a hydroxyl functional group, an amine functional group, an epoxide functional group or an ester functional group.

8. A cathode structure according to claim 1, wherein an electrode loading provided by the electrode is at least 5.0 mAh/cm².

9. A cathode structure according to claim 1, wherein an electrode loading provided by the electrode is at least 5.0 mAh/cm² and less than or equal to 6.0 mAh/cm².

10. A cathode structure according to claim 1, wherein each of the MWCNTs has a first diameter of greater than or equal to 5 nm and less than or equal to 100 nm, and each of the MCFs has a second diameter of greater than or equal to 2 μm and less than or equal to 20 μm and a length of at least 10 μm.

11. A slurry formulation for producing thick electrodes for a battery, comprising:
40-85 weight % of active material; and
0.02-8.0 weight % of multi-walled carbon nanotubes, or 0.05-16.0 weight % of milled carbon fibers, or 0.1-16.0 weight % of a mixture of multi-walled carbon nanotubes and milled carbon fibers;
wherein the slurry formulation has a solids content of greater than 66 weight %.

12. A slurry formulation according to claim 11, further comprising:
5-8.0 weight % of carbon particles and/or single-walled carbon nanotubes.

13. A slurry formulation according to claim 11, further comprising: 0.5-15 weight % of polymeric binder.

14. A slurry formulation according to claim 11, further comprising: 20-50 weight % of a solvent.

15. A method of fabricating a cathode structure for a battery, comprising:
mixing multi-walled carbon nanotubes and/or milled carbon fibers with carbon black and a solvent to produce a first mixture;
mixing a polymeric binder with the first mixture to produce a second mixture;
mixing active material with the second mixture to produce a third mixture;
coating an electrically conductive surface of a substrate with the third mixture to produce a coated substrate; and
heating the coated substrate to a temperature of at least 50° C. so as to substantially remove the solvent.

16. A method according to claim 15, further comprising:
mixing additional solvent with the third mixture.

17. A method according to claim 15, wherein the active material is at least one of lithium manganese oxide, lithium manganese iron phosphate, nickel cobalt manganese aluminum oxide, nickel cobalt aluminum oxide and lithium nickel cobalt manganese oxide.

18. A method according to claim 15, wherein the third mixture has a solids content of greater than 66 weight %.

19. A method according to claim 15, wherein heating the coated substrate produces an electrode having a thickness of greater than 120 μm.

20. A method according to claim 15, wherein each of the multi-walled carbon nanotubes is bonded with a carboxylic acid functional group, a hydroxyl functional group, an amine functional group, and epoxide functional group or an ester functional group.
